(19) United States
(12) Patent Application Publication
(10) Pub. No.: US 2002/0078102 A1
(43) Pub. Date: Jun. 20, 2002

(54) Method and system for customized modification and presentation of remotely saved web content

(75) Inventor: Rabindranath Dutta, Austin, TX (US)

Correspondence Address: Joseph R. Burwell, Law Office of Joseph R. Burwell, P.O. Box 28022, Austin, TX, 78755-8022, US

(73) Assignee: International Business Machines Corporation, Armonk, NY (US)

(21) Appl. No.: 09/740,461

(22) Filed: Dec. 18, 2000

(51) Int. Cl. G06F 15/00

(52) U.S. Cl. 707/526

(57) ABSTRACT

A method, system, apparatus, and computer program product are presented for enabling a user to capture Web content or via a client's Web browser. The captured content is then processed and stored in a customized manner at the server, preferably using user-specifiable scripts. Optional default scripts may also be used. Hyperlinks to the captured content files are conveniently stored in the user's Web page at the server in a manner desired by the user under the control of the server-side scripts. After capturing the content, the user can then access the user's Web page to view the Web page and select the automatically generated hyperlinks. If desired, the user may subsequently edit the Web page to change the hyperlinks, delete hyperlinks, etc. Since the user is able to specify and/or write a script to perform the processing of the pages into which the hyperlinks are placed, the user has significant control over the manner in which the captured content is presented within a user's own Web pages or other files.

### BACKGROUND OF THE INVENTION

1. Field of the Invention

The present invention relates to an improved data processing system and, in particular, to a method and apparatus for multicomputer data transferring. Still more particularly, the present invention provides a method and apparatus for computer-to-computer data storage.

2. Description of Related Art

The commercial use of the Internet has dramatically increased the use of technology. It is now commonplace to assume that individuals and enterprises have access to digital communication services. The amount of electronic communication on the Internet is growing rapidly, as is the amount of content on the World Wide Web.

Many different types of Web-based tools or utilities have been developed to assist users in navigating the Web. For example, when a user is looking for certain information, search engines allow a user to find content, whereas bookmark utilities store Web addresses so that a user can quickly return to Web sites that have content in which the user is interested.

Most of the operations on the Web, including the navigational utilities, can be described with reference to a client-server organizational model. Web-browsers have the ability to store and manage lists of bookmarks as a client-side utility, but many Web portals now offer storage and management of bookmarks as a server-side utility. While browsers have always had the ability to save Web pages being viewed by a user into the user's client-side storage, a browser's save operation generally captures only the main Web page without capturing other content objects which have been linked into the Web page. Small client applications have been developed that allow a user to capture the content of an entire Web page or of an entire Web site into the user's client-side storage. However, some Web sites now offer server-side storage and management of captured content as a server-side utility.

Server-side storage and management of captured Web pages and bookmarks are convenient for mobile users. The bookmarks and captured content are accessible from the server by any client using a browser and an Internet connection rather than being stored on a client that is inaccessible to a mobile user unless the client is running some type of remote access utility.

However, the server-side utilities are rigidly structured; they accept and store captured bookmarks and captured content, but the server controls the manner in which the content is stored for the user. The user is only able to perform certain administrative functions with respect to the content stored at the server.

Therefore, it would be advantageous to have a method and system in which a user could customize server-side storage of captured bookmarks and captured content. It would be particularly advantageous to allow a user to specify customization parameters within a browser.

### SUMMARY OF THE INVENTION

A method, system, apparatus, and computer program product are presented for customizing the storage of captured Web content. The client receives a file, generally a Web page, in response to a request to by a user to browse the Web page. The Web page may be displayed by a browser application, and the user may select a user interface control within the browser that indicates that the user desires to capture the content being displayed by the browser and push the content to the server for customized processing. The browser automatically retrieves an address of a server at which the user has previously established a user account for the capture service. Other user-specified parameters can also be retrieved by the browser for sending to the server. The captured data and user parameters are sent to the server.

The server receives the data, and assuming that the user is authorized for processing data at the server, the server automatically stores the captured data received from the client at the server. In addition, the server automatically retrieves a Web page and automatically modifies the retrieved Web page by inserting a hyperlink to the captured data received from the client. The server then automatically stores the modified Web page. Preferably, the server executes server-side scripts for modifying the Web page. In this manner, the user can customize the manner in which the server processes the Web page and/or the captured data so that the hyperlinks are available in a manner preferred by the user.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2 is a block diagram depicting a typical network in which prior art Web-based services are available from servers to a user at a client machine;

FIG. 3 is a block diagram depicting a Web server for customized storage of captured Web files in accordance with a preferred embodiment of the present invention;

FIGS. 4A-4C depict a set of graphical user interface windows that show the manner in which a user accesses an application to capture Web pages in accordance with a preferred embodiment of the present invention;

FIGS. 5A-5B depict a set of graphical user interface windows that show a simple personal Web page that is modified in accordance with a preferred embodiment of the present invention;

FIG. 5C is an example of a URL generated by the server-side utility for storing captured Web pages is shown in accordance with a preferred embodiment of the present invention; and

FIGS. 6A-6C are a set of flowcharts depicting the various steps that may be used to capture and to customizably process files in conjunction with previously created Web pages in accordance with a preferred embodiment of the present invention.

### DETAILED DESCRIPTION OF THE INVENTION

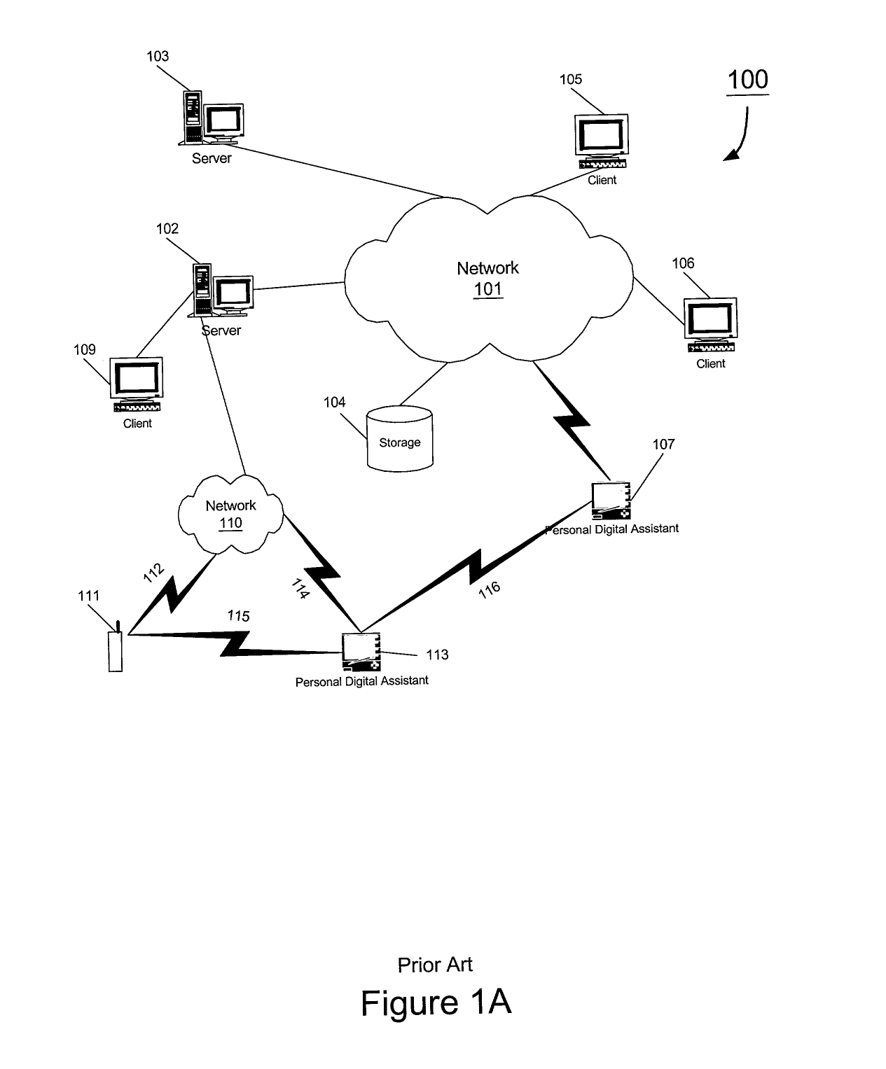

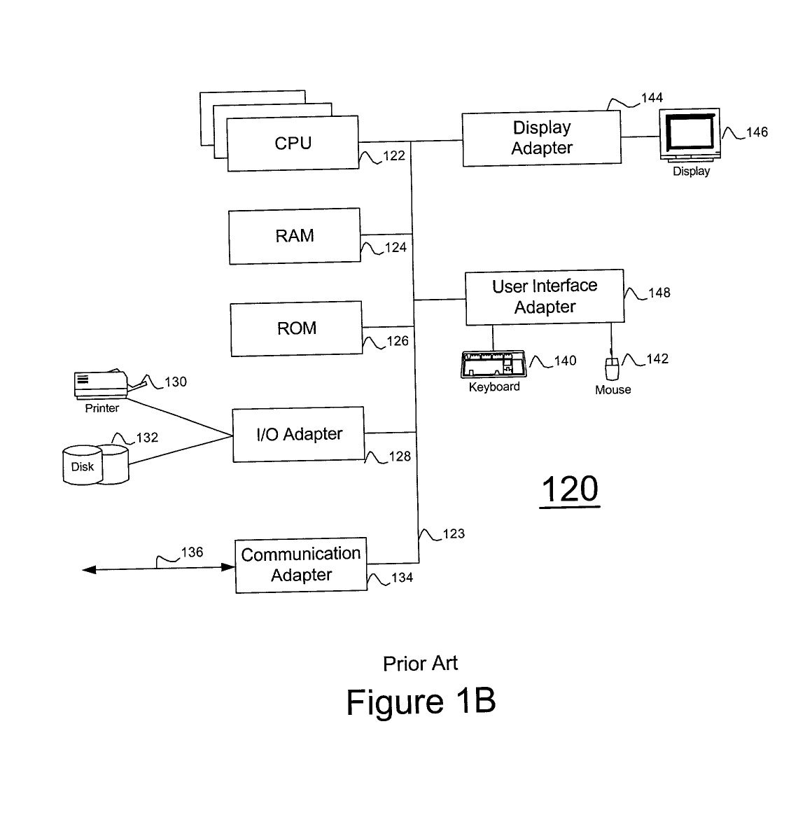

With reference now to the figures, FIG. 1A depicts a typical network of data processing systems, each of which may implement the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. In other words, one of ordinary skill in the art would not expect to find similar components or architectures within a Web-enabled or network-enabled phone and a fully featured desktop workstation. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files. Hence, it should be noted that the distributed data processing system shown in FIG. 1A is contemplated as being fully able to support a variety of peer-to-peer subnets and peer-to-peer services.

The present invention may be implemented on a variety of hardware and software platforms, as described above. More specifically, though, the present invention is directed to providing a methodology for capturing Web content and addresses by a user via a client's Web browser and storing the captured data at a server in a customized manner. Before describing the present invention in more detail, though, some background information is provided about server-side utilities for storing user content so that one may compare the operational efficiencies and other advantages of the present invention.

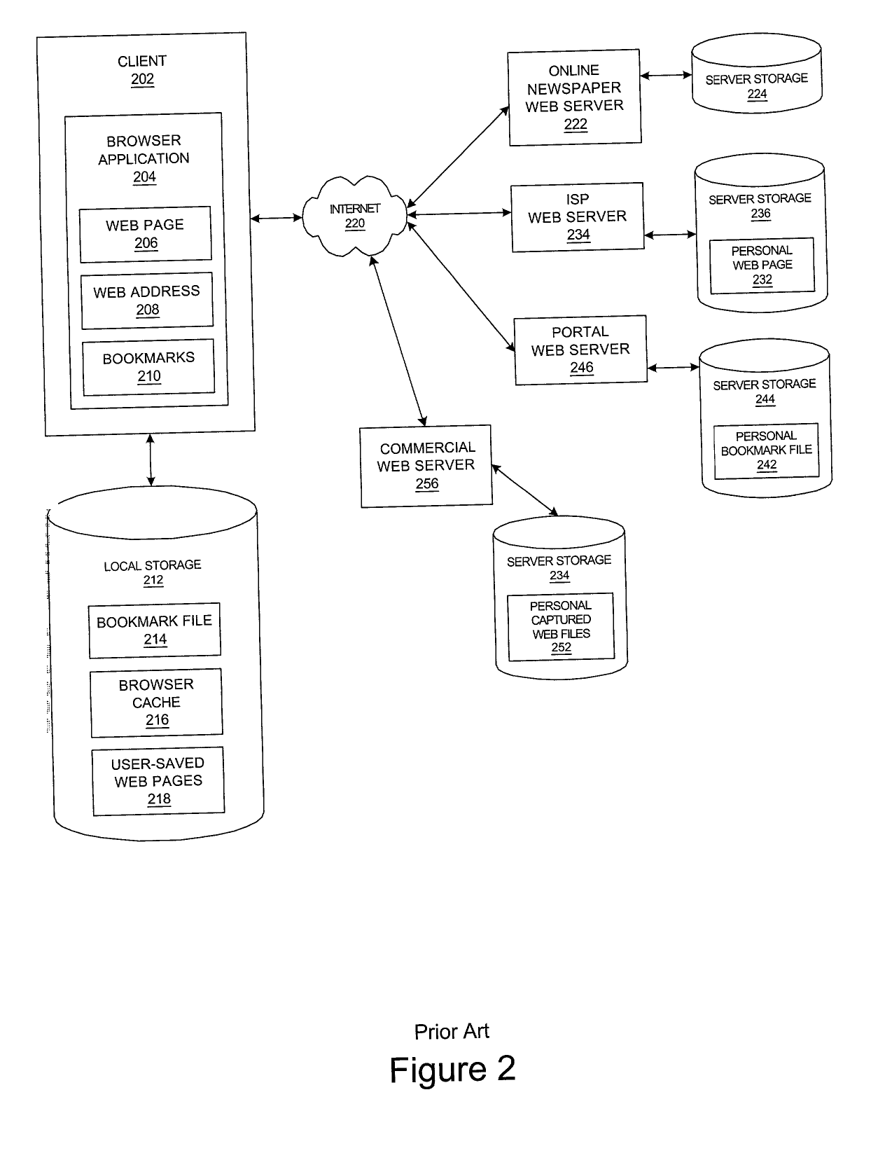

With reference now to FIG. 2, a block diagram depicts a typical network, similar to FIG. 1, in which prior art Web-based services are available from servers to a user at a client machine. Client 202 runs browser application 204, which displays web page 206 retrieved from Web address 208. Browser 204 may display various types of content other than Web pages, and the location of the content may be represented by a variety of addresses, such as Uniform Resource Locators (URLs) and Uniform Resource Identifiers (URIs). Browser 204 may also maintain bookmarks 210 for selection by a user.

Client 202 maintains local storage 212 for use by browser application 204 and other applications. Browser 204 may store bookmark file 214, browser cache 216, and various types of files, including user-saved Web pages 218.

Client 202 accesses various resources and services throughout the Internet 220. For example, a user may browse content from an online newspaper supported by server 222 and stored within server storage 224. A user may browse his/her own personal Web page 232 supported by an Internet Service Provider (ISP) server 234 connected to storage 236.

Various portal services are operated on the World Wide Web and generally contain large amounts of information. In order to attract users to view advertisements on Web pages, some portals offer the ability of users to store information on a server so that the information is available to the user from more than one client device, which is particularly useful if the user accesses the Internet from more than one machine.

A user at client 202 may store personal bookmark file 242 within storage 244 connected to portal Web server 246. By storing or replicating a copy of a browser bookmark file on the server, the user can have access to the bookmarks from almost any Web-enabled device throughout the Internet.

In a similar manner, a user may store personal captured Web files 252 within storage 254 connected to Web server 256, which may be a commercial service or may be another free service supported by another portal or other type of Web site. As is known in the prior art and depicted within FIG. 2, after viewing a Web page, a user may decide to capture one or more Web pages. A user may execute a client-side utility to capture one or more Web pages and store the pages locally at the client. If desired, the user may then transfer copies of the captured files for remote storage in a so-called “virtual hard drive”. By storing the captured Web files on the server, the files are available to the user from almost any Web-enabled device throughout the Internet. In addition, as the user accesses the Internet from multiple devices, personal captured Web files 252 provides a central location for organizing, viewing, or forwarding the files.

Other prior art services allow a user to transfer files in a very limited manner from one server to another server. For example, the operator of Web server 222 may have a cooperative arrangement with the operator of server 232, and the Web pages at server 222 may contain hypertext links that, when selected by the user, immediately transfer the Web page from server 222 to server 232, assuming that the user supplies the proper authorization information to store the information within the user's account at server 232.

In another prior art service, after viewing a Web page, a user may decide to capture one or more Web pages. The user may select a control within a toolbar of the browser application to capture one or more Web pages and store the pages remotely at the server. The user may then view the captured files in a hierarchically structured, file-system-type manner similar to viewing files within directories on the client. For example, the files can be arranged into folders, sent to other users, etc.

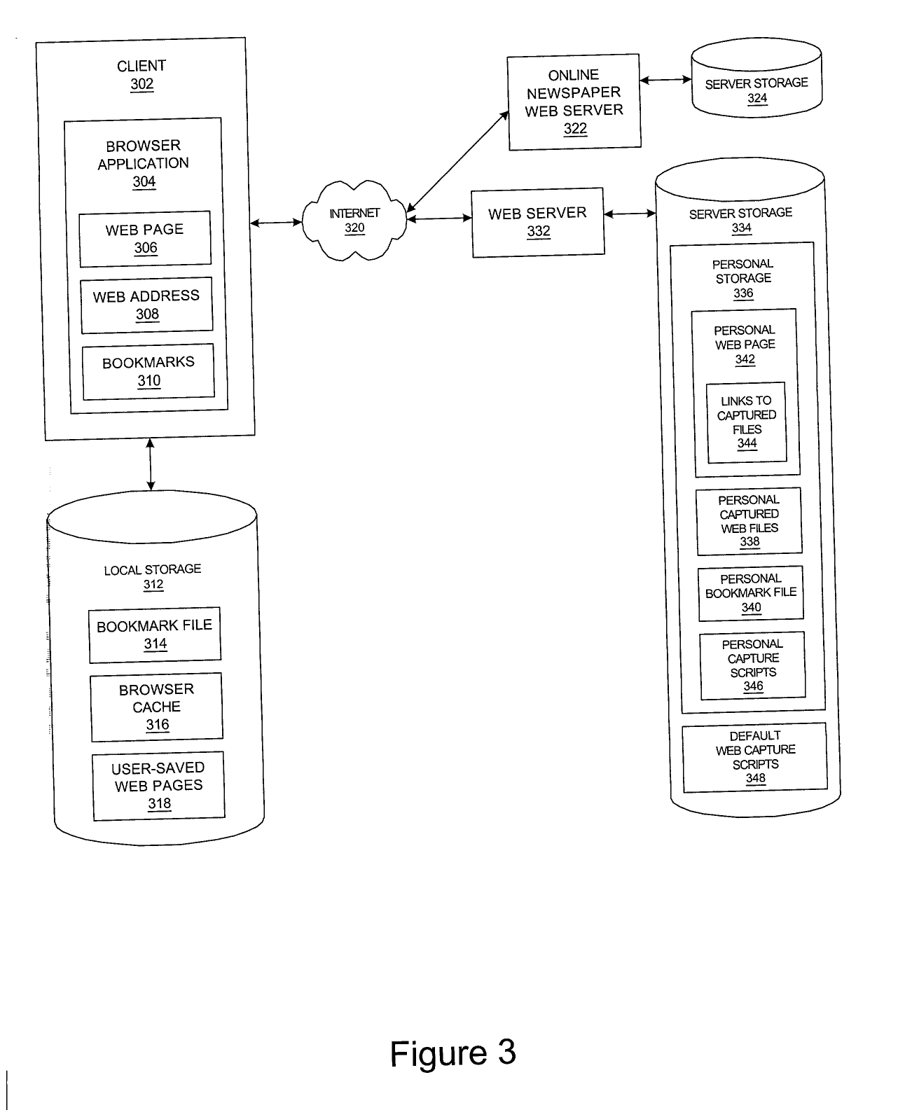

With reference now to FIG. 3, a block diagram depicts a Web server for customized storage of captured Web files in accordance with a preferred embodiment of the present invention. In a manner similar to FIG. 2, FIG. 3 shows various components within the Internet that a user may access to retrieve information. Client 302 runs browser application 304, which displays web page 306 retrieved from Web address 308. Browser 304 may also maintain bookmarks 310 for selection by a user using application options and controls within browser 304. Client 302 maintains local storage 312; browser 304 may store bookmark file 314, browser cache 316, and various types of files, including user-saved Web pages 318. Client 302 accesses various resources and services throughout the Internet 320. In this example, a user may browse content from an online newspaper supported by server 322 and stored within server storage 324.

The present invention provides a methodology by which a user may browse Web pages and then, when desired, capture those Web pages for later viewing, editing, or other processing in a customized manner. By selecting an application control within browser 304, a user can request that browser 304 push Web page 306 to server 332, which stores the captured Web page in server storage 334. It should be noted that other types of content may also be captured other than Web pages, such as graphic files, text files, audio and video files, general binary data files, etc.

It is assumed that the user of client 302 has previously registered in some manner to create a personal account so that the user is authorized by the owner or operator of server 332 to access services provided via server 332. After the user has been registered, the user is allocated a certain amount of online storage space 336 in which the user may store various types of data. In a manner similar to that shown in FIG. 2, captured Web files 338 and personal bookmark file 340 may be stored in storage 334.

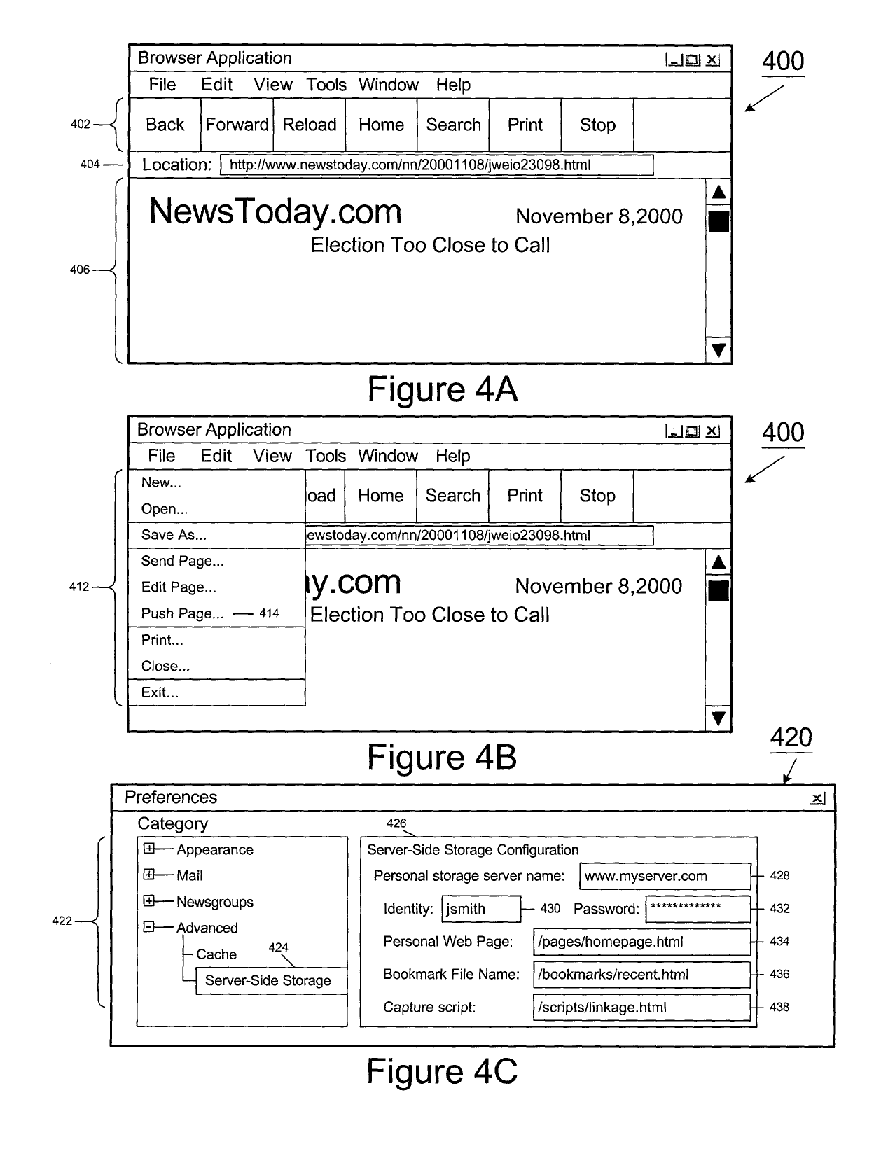

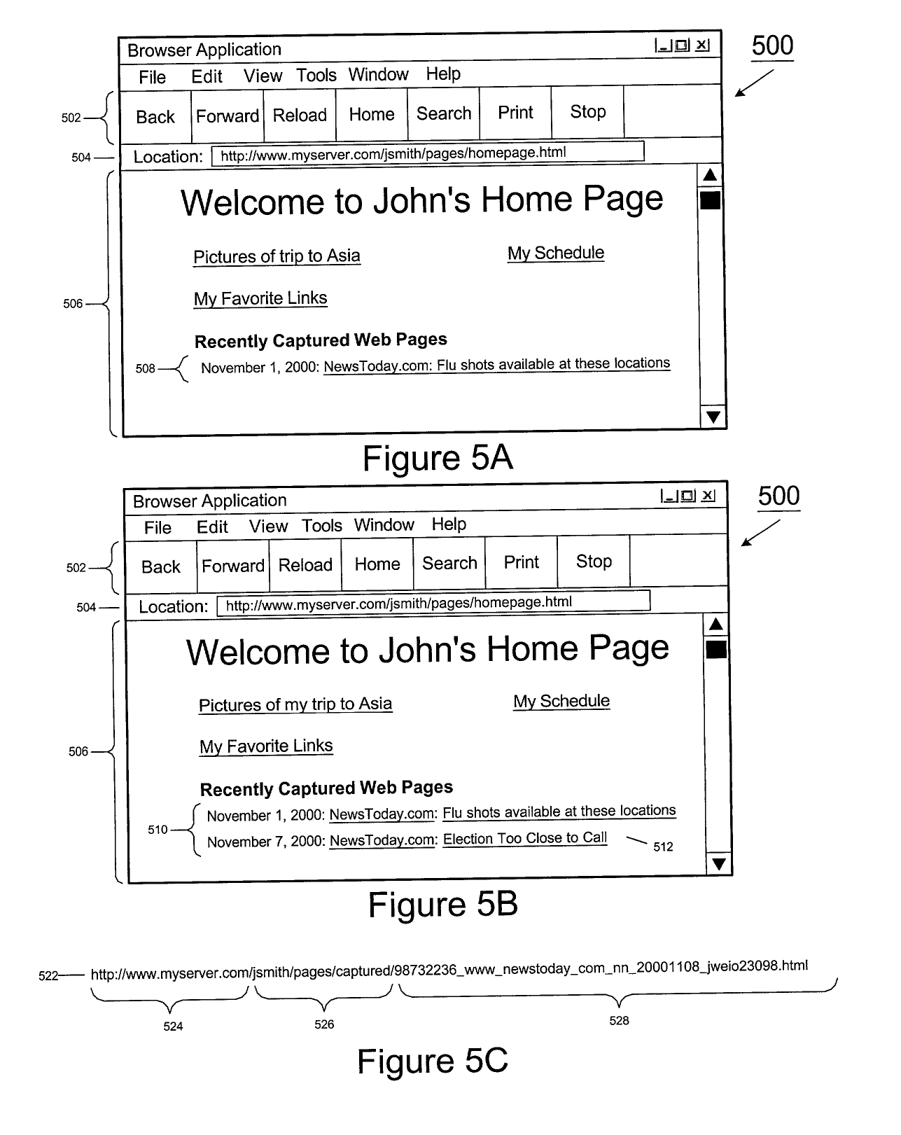

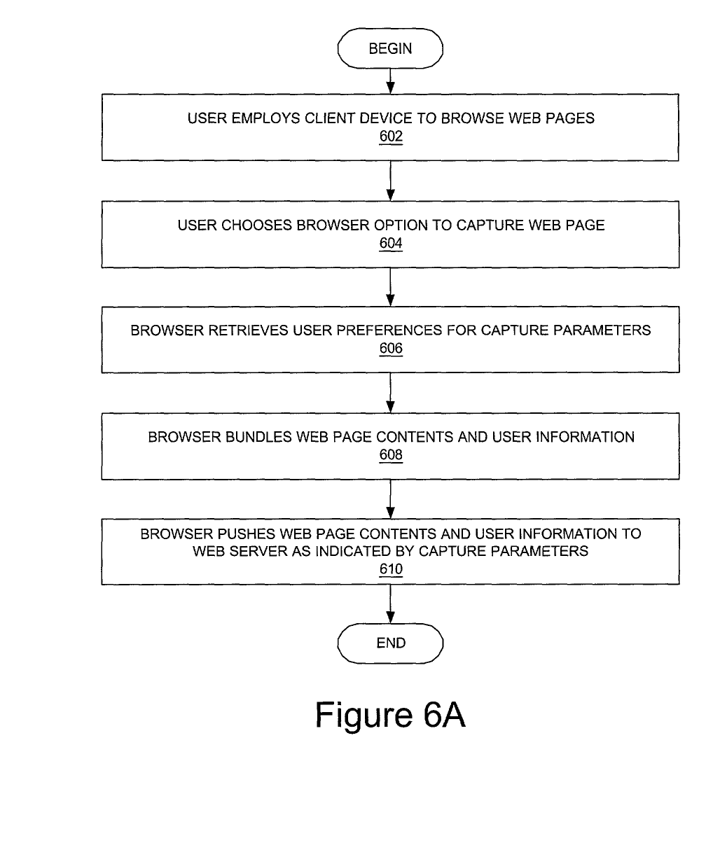

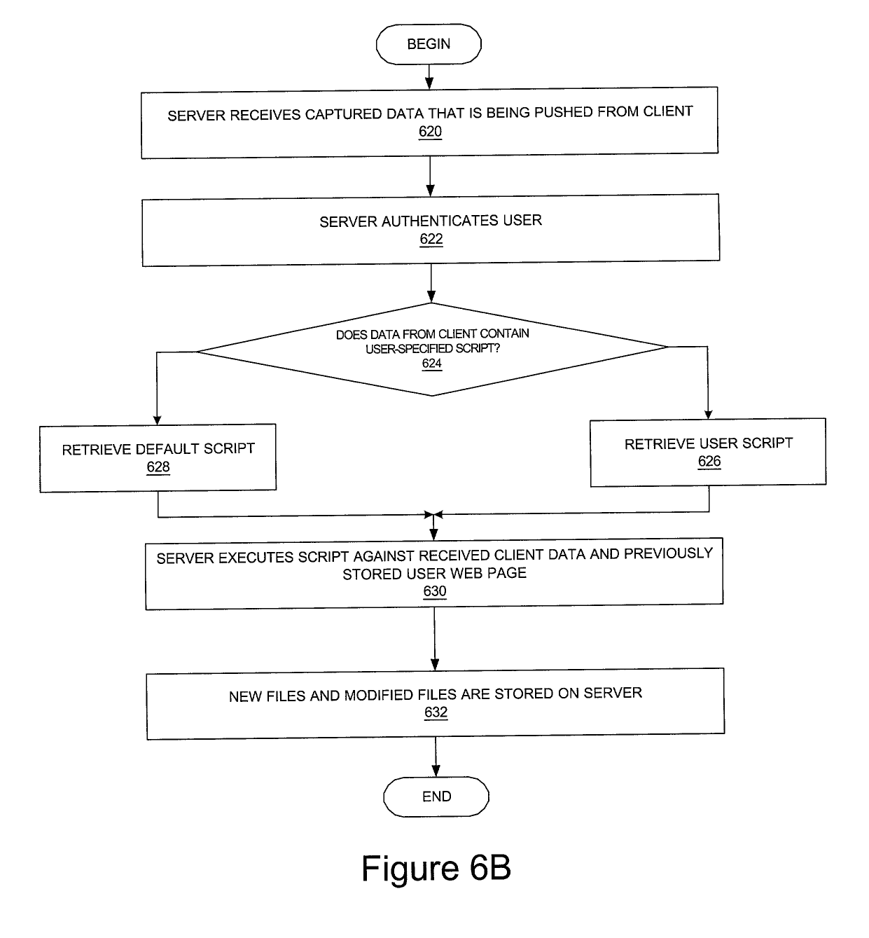

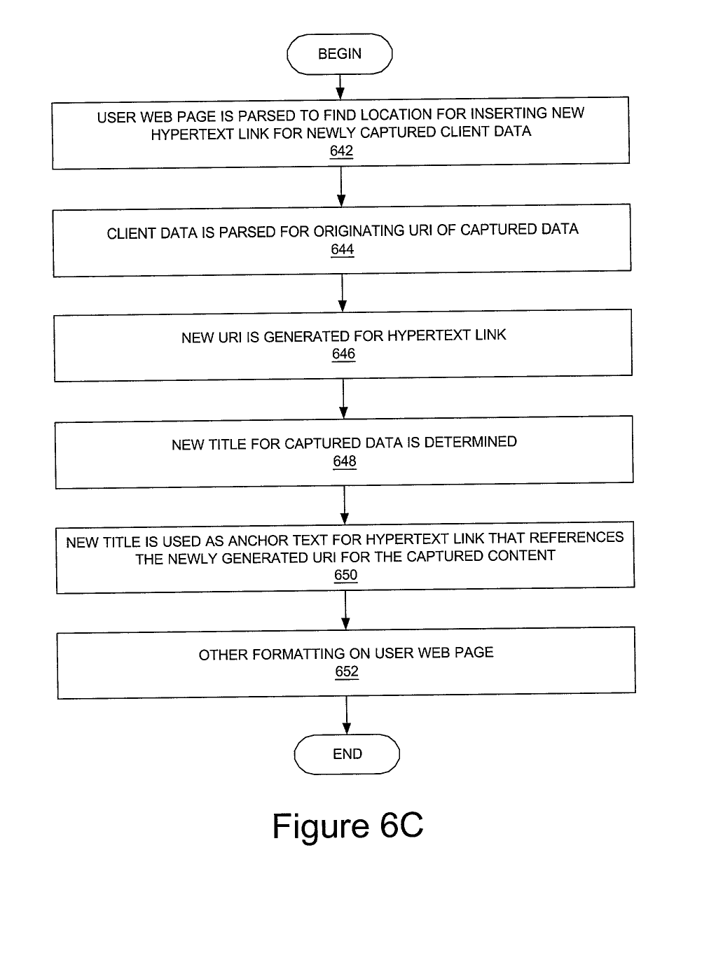

In contrast to the prior art, however, a user's personal Web page 342 contains links 344 to the captured Web files, and the links have been created by executing one or more server-side scripts, Java applets, etc., such as personal capture scripts 346 or default capture scripts 348. During the operation of pushing the captured data to the server, the server runs one or more scripts against the incoming data and the previously stored Web pages in order to automatically create hypertext links within a user's personal Web page in a customized manner. FIGS. 4A-4C shown the manner in which a user can capture Web pages or other files. FIGS. 5A-5B show a simple example of the manner in which a Web page can be customizably modified to include links to captured data. FIGS. 6A-6C show a set of flowcharts that depict the various steps that may be used to capture and customizably process files in conjunction with previously created Web pages.

With reference now to FIGS. 4A-4C, a set of graphical user interface windows show the manner in which a user accesses an application to capture Web pages in accordance with a preferred embodiment of the present invention. Referring to FIG. 4B, window 400 shows a typical browser application for viewing Web pages or other Internet-based or Web-based content. Buttons 402 allow a user to navigate through various Web sites, while location indicator 404 shows the address of the Web site of the Web page that is being viewed by the user or the address being retrieved by the browser. Content area 406 shows the actual content to the user.

Referring to FIG. 4B, window 400 shows file menu 412, as might be similarly found in prior art browsers. However, in the present invention file menu 412 contains menu item 414 which enables a user to invoke the capture facility of the present invention for capturing content within the browser and pushing the content to a Web server. Alternatively, other application controls could be available to the user, such as alternate-button-click on the mouse attached to the client device, sometime called the “right-click” features. Other controls, such as a control button within a toolbar, may also be used.

Referring to FIG. 4C, window 420 depicts a preference dialog box through which a user specifies preferences for optional ways in which the browser may operate. As is typical in many browsers, a user may select various options, and the browser changes the manner in which it operates in accordance with the chosen preferences. The options are organized into categories 422. In this example, category 424 for “server-side storage” is depicted as having been chosen by a user.

Server-side storage configuration preferences 426 depict various fields that a user may use to specify the parameters may be needed by a server that operates the server-side functionality of the present invention. Entry field 428 allows a user specify the location of the server to which captured data should be pushed for storage and processing. Entry fields 430 and 432 allow a user to specify a user identity and password for a user account at the server specified within entry field 428. The browser will forward this information to the server in order to obtain authorization for the user to perform various processes at the server. It should be understood that various mechanism may be used to authenticate a user, such as using a cookie mechanism placed in the client's cookie cache by the server, depending upon the level of security desired by the operator of the server.

Entry field 434 allows a user to specify an address, relative to the server address, for the user's personal Web page that is to be modified to receive hypertext links to captured Web content that has been stored on the server. Entry field 436 allows a user to specify an address of a bookmark file that stores the user's bookmarks at the server. Entry field 438 allows a user to specify a script that is to be executed at the server; the script customizes the manner in which Web content that has been captured at the client and pushed to the server is then processed in conjunction with other Web pages that have previously been stored on the server.

With reference now to FIGS. 5A-5B, a set of graphical user interface windows show a simple personal Web page that is modified in accordance with a preferred embodiment of the present invention. Referring to FIG. 5A, window 500 shows a typical browser application for viewing Web pages or other Internet-based or Web-based content. Buttons 502 allow a user to navigate through various Web sites, while location indicator 504 shows the address of the Web site of the Web page that is being viewed by the user or the address being retrieved by the browser. Content area 506 shows the actual content to the user. In this example, window region 508 contains hypertext links to Web pages that have been captured at the client and pushed to the server. Region 508 contains one hypertext link to a content item that was captured at a specific date; a link to the original URI of the content or to the URI of its Web site is provided; and a hypertext link to the content as stored within the user's personal storage space on the server is also provided. The text of the hypertext link may be derived from the content of the captured content.

Referring to FIG. 5B, window 500 shows the contents of the user's Web page after the user at the client has selected to capture a Web page, such as the Web page shown in FIGS. 4A-4B, at the user's client and push the Web page to the server using the present invention. After the server received the captured content, the server processed the content through one or more scripts, and the user's Web page was modified by the scripts. Although the user may rely upon the default scripts, the user is able to write or modify other scripts and store those scripts within the server. This allows the user to customize the manner in which the user's Web page, pages, or other files are modified. Region 510 within the Web page now contains another hypertext link 512 to the content item that the user requested to capture.

With reference now to FIG. 5C, an example of a URL generated by the server-side utility for storing captured Web pages is shown in accordance with a preferred embodiment of the present invention. Preferably, in order to organize the captured content files on the server as they are captured and received from the client, the server automatically assigns a URL to the captured files. In this example, URL 522 contains various portions that depicts a manner of generating unique URLs for multiple users that use the service provided at the server. URL portion 524 shows the address of the Web server or domain at which a service providing the functionality of the present invention may be found. URL portion 526 is the user-relative address that specifies the directory in which the user's captured files are generally stored. This relative address may match a user-specifiable parameter within the user's browser.

URL portion 528 is a unique file name that is generated for a captured file. The original URL may be modified in some manner to, such as replacing certain characters with an underscore character. In addition, some URL merely point to an active Web page that changes day-by-day; the user specifies the same URL to reach a Web page, but the contents of the Web page may change frequently while the URL remains the same. Hence, the user may attempt to capture unique content at a given static URL or URI at different times, and the URL or URI should be modified in some manner so that when the captured file or files are transferred to the server, the file names do not collide. In this case, an unique hash value or time stamp might be prefixed to the URL portion prior to storing the file on the server.

In this manner, URL 522 may be used as the referenced resource within an hypertext anchor that is placed within a Web page, e.g. by using URL 522 as a reference in an anchor tag within a Web page structured in accordance with HTML formatting rules. It should be understood, however, that the graphical item that represents a link to the captured content may vary in a variety of manners as is known in the graphical user interface arts. For example, icons may also be embedded within the user's page and used as hyperlinks.

With reference now to FIGS. 6A-6C, a set of flowcharts depict the various steps that may be used to capture and customizably process files in conjunction with previously created Web pages in accordance with a preferred embodiment of the present invention. Referring to FIG. 6A, the process begins with the user browsing Web pages with a browser application (step 602), after which the user indicates that the user desires to capture the content of the Web page by selecting the appropriate browser control within the browser application (step 604). The browser then retrieves the previously specified user preferences for the capture parameters (step 606) and bundles the necessary information together with the captured content (step 608). The format for the information can vary depending upon the needs to the server. The data may be pushed to the server by the browser using a simple HTTP “Put” message. Other message types may be used as the present invention is not dependent upon a particular format for the transfer of data.

The browser might need to establish a secure session with the server using the user's identity and password; after establishing a session, the browser can then package the content together with its originating URI, the name of the user's preferred directory, the name of the preferred script, and the name of the preferred file to be used to store the hypertext link to the captured content. The browser then pushed the bundled information to the server at the previously specified address (step 610), and the client-side process is complete.

Referring to FIG. 6B, the server-side process begins with the server receiving the captured content data and other information that is being pushed from the client to the server (step 620). The server, if it has not already done so, may need to authenticate and authorize the user that is requesting the service (step 622). A determination is then made as to whether the data from the client contains a user-specified script (step 624). If so, then the user's script is retrieved (step 626); otherwise, a default script may be retrieved (step 628). It should be understood that the server application may have the necessary functionality embedded within it, and the default processing may be provided by a particular server application, i.e., it does not necessarily have to be placed within a default script.

The server then executes the retrieved script against the received client data and the previously stored user Web page or files (step 630). After the data has been processed, new files are created for the actual captured content, while the user's Web files that were previously stored within the server's storage are modified to include hyperlinks to the captured content (step 632). The overall process is then complete.

FIG. 6C provides further detail for the manner in which the server processes the received client data shown as step 630 in FIG. 6B. The process begins with the server parsing the previously stored user Web page for a location at which to insert the new hyperlink to the newly captured data (step 642). For example, a special markup language tag may be placed within the Web page to demarcate the beginning of the special hyperlinks to the user's captured Web files, and the server or script scans for the special tag.

The server can then parse the client data for an originating URI for the captured data (step 644) while the server generates a new URI or URL for the hyperlink to be associated with the captured content when it is stored within the server's domain (step 646). The manner in which the client data is parsed may vary. For example, rather than capturing an entire Web page, a user may merely copy the URL/URI of the Web page and push the URL/URI to the server as a compact data file. Depending on what is captured and pushed to the server, various content-type indicators may be used to indicate to the server what type of content is being sent, thereby implying the manner in which the content should be processed. In this manner, the URL of a Web page could be captured, pushed to the server, and stored as a hyperlink within the user's Web page. In that case, the hyperlink would not have any associated captured content files.

A new title for the captured data may also be determined (step 648), and the new title may be used as the anchor text for a hypertext link that is placed within the modified user Web page such that the hyperlink references the captured data at the proper location within the server's domain (step 650). The script may perform other formatting activities on the user's Web page as desired by the user or the server operator (step 652), and the process is then complete.

The advantages of the present invention should be apparent in view of the detailed description of the invention that is provided above. In the prior art, a user may capture Web content and store the captured content at a server. Although having the content stored on the server was convenient, the user had little control over the manner in which the captured content was organized. While the user could manipulate the organization of the captured files in accordance with a typical hierarchical system for organizing files in folders, etc.

In contrast, the present invention enables a user to capture Web content or merely URIs via a client's Web browser; the captured content or URIs are then processed and stored in a customized manner at the server. After capturing the content, the user can view the user's Web page. Hyperlinks to the captured content files are conveniently stored in the user's Web page in the manner desired by the user rather than the manner mandated by the service at the server. If desired, the user may subsequently edit the Web page to change the hyperlinks, delete hyperlinks, etc. Since the user is able to specify and/or write a script to perform the processing of the pages into which the hyperlinks are placed, the user has significant control over the manner in which the captured content is presented within a user's own Web pages or other files.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for processing data within a distributed data processing system, the method comprising:
receiving, at a client, a first file in response to a request to by a user to browse the first file;
displaying content from the first file by a client application;
selecting a user interface control within the client application;
in response to the selection of the user interface control, automatically retrieving an address of a server, wherein the user has previously established a user account at the server;
in response to the selection of the user interface control, automatically retrieving user-specified parameters within the client application, wherein the user-specified parameters are associated the user account at the server for server-side processing of files sent by the user to the server; and
automatically sending the first file with the retrieved user-specified parameters from the client to the server using the retrieved address.

2. The method of claim 1 further comprising:
determining that the first file references a plurality of files;
receiving at the client the plurality of files;
sending the plurality of files with the first file to the server.

3. The method of claim 1 wherein the address is a Uniform Resource Identifier (URI).

4. The method of claim 1 wherein the first file is formatted in accordance with a markup language.

5. A method for processing data within a distributed data processing system, the method comprising:
receiving, at a server, one or more files from a user at a client, wherein the user has previously established a user account at the server;
authorizing the user for processing data at the server;
in response to authorizing the user, automatically storing the one or more received files from the client at the server;
in response to authorizing the user, automatically retrieving a Web page from local storage at the server;
automatically modifying the retrieved Web page by inserting a hyperlink to at least one of the one or more received files from the client; and
automatically storing the modified Web page.

6. The method of claim 5 wherein the Web page is retrieved from local storage at the server.

7. The method of claim 5 wherein the Web page may be edited by the user.

8. The method of claim 5 further comprising:
parsing at least one received file from the client to retrieve an originating Uniform Resource Identifier (URI);
generating one or more URIs for storing the one or more received files at the server; and
storing the one or more received files to be accessible using the one or more generated URIs.

9. The method of claim 8 wherein the inserted hyperlink references a received file using a generated URI.

10. The method of claim 8 wherein the inserted hyperlink is associated with anchor text derived from content within a received file.

11. The method of claim 10 wherein the anchor text is a title of a received file.

12. The method of claim 5 further comprising:
executing a server-side script against the one or more received files and the retrieved Web page.

13. The method of claim 12 further comprising:
determining whether a user has specified a server-side script; and
in response to a determination that the user has specified a server-side script, executing the specified server-side script.

14. The method of claim 13 further comprising:
parsing at least one received file from the client to retrieve the specified server-side script.

15. The method of claim 5 further comprising:
parsing at least one received file from the client to retrieve a user-specified processing parameter, wherein the user-specified processing parameter identifies the Web page to be retrieved.

16. An apparatus for processing data within a distributed data processing system, the apparatus comprising:
first receiving means for receiving, at a client, a first file in response to a request to by a user to browse the first file;
displaying means for displaying content from the first file by a client application;
selecting means for selecting a user interface control within the client application;
first retrieving means for automatically retrieving, in response to the selection of the user interface control, an address of a server, wherein the user has previously established a user account at the server;
second retrieving means for automatically retrieving, in response to the selection of the user interface control, user-specified parameters within the client application, wherein the user-specified parameters are associated the user account at the server for server-side processing of files sent by the user to the server; and
first sending means for automatically sending the first file with the retrieved user-specified parameters from the client to the server using the retrieved address.

17. The apparatus of claim 16 further comprising:
determining means for determining means for determining that the first file references a plurality of files;
second receiving means for receiving at the client the plurality of files;
second sending means for sending the plurality of files with the first file to the server.

18. The apparatus of claim 16 wherein the address is a Uniform Resource Identifier (URI).

19. The apparatus of claim 16 wherein the first file is formatted in accordance with a markup language.

20. An apparatus for processing data within a distributed data processing system, the apparatus comprising:
receiving means for receiving, at a server, one or more files from a user at a client, wherein the user has previously established a user account at the server;
authorizing means for authorizing the user for processing data at the server;
first storing means for automatically storing, in response to authorizing the user, the one or more received files from the client at the server;
retrieving means for automatically retrieving, in response to authorizing the user, a Web page from local storage at the server;
modifying means for automatically modifying the retrieved Web page by inserting a hyperlink to at least one of the one or more received files from the client; and
second storing means for automatically storing the modified Web page.

21. The apparatus of claim 20 wherein the Web page is retrieved from local storage at the server.

22. The apparatus of claim 20 wherein the Web page may be edited by the user.

23. The apparatus of claim 20 further comprising:
first parsing means for parsing at least one received file from the client to retrieve an originating Uniform Resource Identifier (URI);
generating means for generating one or more URIs for storing the one or more received files at the server; and
third storing means for storing the one or more received files to be accessible using the one or more generated URIs.

24. The apparatus of claim 23 wherein the inserted hyperlink references a received file using a generated URI.

25. The apparatus of claim 23 wherein the inserted hyperlink is associated with anchor text derived from content within a received file.

26. The apparatus of claim 25 wherein the anchor text is a title of a received file.

27. The apparatus of claim 20 further comprising:
first executing means for executing a server-side script against the one or more received files and the retrieved Web page.

28. The apparatus of claim 27 further comprising:
determining means for determining whether a user has specified a server-side script; and
second executing means for executing in response to a determination that the user has specified a server-side script, the specified server-side script.

29. The apparatus of claim 28 further comprising:
second parsing means for parsing at least one received file from the client to retrieve the specified server-side script.

30. The apparatus of claim 20 further comprising:
third parsing means for parsing at least one received file from the client to retrieve a user-specified processing parameter, wherein the user-specified processing parameter identifies the Web page to be retrieved.

31. A computer program product in a computer readable medium for use in a data processing system for remotely storing data, the computer program product comprising:
instructions for receiving, at a client, a first file in response to a request to by a user to browse the first file;
instructions for displaying content from the first file by a client application;
instructions for selecting a user interface control within the client application;
instructions for automatically retrieving, in response to the selection of the user interface control, an address of a server, wherein the user has previously established a user account at the server;
instructions for automatically retrieving, in response to the selection of the user interface control, user-specified parameters within the client application, wherein the user-specified parameters are associated the user account at the server for server-side processing of files sent by the user to the server; and
instructions for automatically sending the first file with the retrieved user-specified parameters from the client to the server using the retrieved address.

32. The computer program product of claim 31 further comprising:
instructions for determining that the first file references a plurality of files;
instructions for receiving at the client the plurality of files;
instructions for sending the plurality of files with the first file to the server.

33. The computer program product of claim 31 wherein the address is a Uniform Resource Identifier (URI).

34. The computer program product of claim 31 wherein the first file is formatted in accordance with a markup language.

35. A computer program product in a computer readable medium for use in a data processing system for storing data, the computer program product comprising:
instructions for receiving, at a server, one or more files from a user at a client, wherein the user has previously established a user account at the server;
instructions for authorizing the user for processing data at the server;
instructions for automatically storing, in response to authorizing the user, the one or more received files from the client at the server;
instructions for automatically retrieving, in response to authorizing the user, a Web page from local storage at the server;
instructions for automatically modifying the retrieved Web page by inserting a hyperlink to at least one of the one or more received files from the client; and
instructions for automatically storing the modified Web page.

36. The computer program product of claim 35 wherein the Web page is retrieved from local storage at the server.

37. The computer program product of claim 35 wherein the Web page may be edited by the user.

38. The computer program product of claim 35 further comprising:
instructions for parsing at least one received file from the client to retrieve an originating Uniform Resource Identifier (URI);
instructions for generating one or more URIs for storing the one or more received files at the server; and
instructions for storing the one or more received files to be accessible using the one or more generated URIs.

39. The computer program product of claim 38 wherein the inserted hyperlink references a received file using a generated URI.

40. The computer program product of claim 38 wherein the inserted hyperlink is associated with anchor text derived from content within a received file.

41. The computer program product of claim 40 wherein the anchor text is a title of a received file.

42. The computer program product of claim 35 further comprising:
instructions for executing a server-side script against the one or more received files and the retrieved Web page.

43. The computer program product of claim 42 further comprising:
instructions for determining whether a user has specified a server-side script; and
instructions for executing, in response to a determination that the user has specified a server-side script, the specified server-side script.

44. The computer program product of claim 43 further comprising:
instructions for parsing at least one received file from the client to retrieve the specified server-side script.

45. The computer program product of claim 35 further comprising:
instructions for parsing at least one received file from the client to retrieve a user-specified processing parameter, wherein the user-specified processing parameter identifies the Web page to be retrieved.
